(19) United States
(12) Patent Application Publication
(10) Pub. No.: US 2010/0111536 A1
(43) Pub. Date: May 6, 2010

(54) Communication network and design method

(75) Inventors: Shigeru Ishii, Kawasaki (JP); Takehiro Fujita, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/654,072

(22) Filed: Dec. 9, 2009

Related U.S. Application Data
(63) Continuation of application No. PCT/JP07/63596, filed on Jul. 6, 2007.

(51) Int. Cl. H04J 14/02

(52) U.S. Cl. 398/81; 398/192

(57) ABSTRACT

A communication network includes a starting node that has a variable dispersion compensator that performs dispersion compensation at a variable dispersion compensation amount such that a residual dispersion amount of an optical signal transmitted therethrough becomes a predetermined reference residual dispersion amount; and plural nodes that are subjected to dispersion compensation design using the starting node as a starting point and that include fixed dispersion compensators selected based on the reference residual dispersion amount.

### FIELD

The embodiments discussed herein are related to a communication network and a design method.

### BACKGROUND

Wavelength division multiplexing (WDM) transmitting apparatuses are increasingly in demand with recent increases in traffic in communication networks. WDM transmitting apparatuses have been actively introduced in local networks (metro networks).

Although a local network typically takes a form of a ring communication network, it is projected that a shift to mesh communication networks will be made to flexibly support traffic demands in the future. If an optical signal of 10 Gb/s or more is propagated over a long distance, the optical waveform deteriorates due to nonlinear optical effects such as wavelength dispersion in the optical fiber and self phase modulation (SPM) generated in the optical fiber.

To compensate the deterioration of the optical waveform due to wavelength dispersion, dispersion compensation by a dispersion compensator is performed. Dispersion compensators utilized include, for example, a dispersion compensating fiber (DCF) having a fixed dispersion compensation amount and a virtually imaged phased array (VIPA) variable dispersion compensator having a variable dispersion compensation amount.

In ring and mesh communication networks, optical add drop multiplexers (OADM) are used for inserting an optical signal transmitted from another communication network and branching an optical signal to another communication network (see, for example, Japanese Laid-Open Patent Publication No. 2006-135788 and International Publication Pamphlet No. 2004/098102).

FIG. 14 is a block diagram of a functional configuration of a conventional ring communication network. As depicted in FIG. 14, a conventional communication network 1400 is reconfigurable OADM (ROADM) made up of four nodes #1 to #4 connected in a ring shape. ROADM is one form of OADM and is a remote-wavelength-controllable wavelength multiplexing device.

The communication network 1400 transmits a WDM optical signal, which is a wavelength-multiplexed optical signal, and branches an optical signal of each wavelength (channel) included in the WDM optical signal to another communication network or inserts an optical signal transmitted from another communication network into the WDM optical signal. Each of the nodes #1 to #4 is a ROADM node including a fixed dispersion compensator.

A path 1410 is a path of an optical signal inserted from another communication network into the node #1, passing through the nodes #2 to #4, and returning to the node #1. A path 1420 indicates a path of an optical signal inserted from another communication network into the node #4, passing through the nodes #1 to #3, and branched from the node #3 to another communication network.

FIG. 15 is a block diagram of a functional configuration of a ROADM node. A ROADM node 1500 is an exemplary configuration of each of the nodes #1 to #4 depicted in FIG. 14 and branches (drops) a portion of the WDM optical signal wavelength-multiplexed and transmitted from another ROADM node of the communication network 1400 and transmits the portion to another communication network through an interface unit 1560.

The ROADM node 1500 receives an optical signal transmitted from another communication network through the interface unit 1560 and inserts (adds) the optical signal into the WDM optical signal passing through the ROADM node 1500. A fixed dispersion compensator 1501 performs dispersion compensation, by a fixed dispersion compensation amount, on a WDM optical signal transmitted from another ROADM node of the communication network 1400.

FIG. 16 is a diagram depicting changes in a cumulative residual dispersion amount in a communication network. In FIG. 16, the horizontal axis indicates the distance of a path of an optical signal and the nodes #1 to #4 through which the optical signal passes. The vertical axis indicates the cumulative residual dispersion amount of the optical signal passing through the paths 1410, 1420 depicted in FIG. 14.

A dotted line 1610a indicates changes in the cumulative dispersion amount when the optical signal is inserted from the node #1 as in the case of the path 1410. The nodes #1 to #4 are equipped with respective fixed dispersion compensators and the cumulative dispersion amount is reduced at each of the nodes #1 to #4. As a result, the cumulative dispersion amount changes at the nodes #1 to #4 as indicated by the dotted line 1610a.

A dotted line 1620a indicates changes in the cumulative dispersion amount when an optical signal is inserted from the node #4 as in the case of the path 1420. As a result, the cumulative dispersion amount changes in the nodes #1 to #4 as indicated by the dotted line 1620a. Reference numeral 1630 denotes an ideal residual dispersion amount (hereinafter, “RDtgt”) in the nodes #1 to #4 when the optical signal is inserted from the node #1.

Reference numeral 1640 denotes dispersion tolerance in the communication network 1400 when the optical signal is inserted from the node #1. The dispersion tolerance is a range of the residual dispersion amount necessary for acquiring predetermined characteristics on the receiving side. Reference numeral 1650 denotes RDtgt in the communication network 1400 when the optical signal is inserted from the node #4.

Due to the nonlinear optical effects such as self-phase modulation generated in the optical fiber, chirp is generated. Therefore, as denoted by reference numerals 1630, 1640, and 1650, the RDtgt and the dispersion tolerance in the communication network vary depending on the number of the nodes through which the optical signal passes and the span between the nodes.

FIG. 17 is a diagram depicting dispersion compensation design in a conventional ring communication network. In FIG. 17, the horizontal axis indicates nodes #1 to #4 through which the optical signal passes. The vertical axis indicates a deviation amount between the residual dispersion amount and RDtgt of the optical signal passing through the paths 1410, 1420. It will hereinafter be assumed that the residual dispersion of the optical signal inserted into the communication network 1400 is RDtgt.

A solid line 1710 is a design example of the dispersion compensation using the node #1 as a starting node. On the assumption that an optical signal having the residual dispersion amount of RDtgt is inserted from another communication network to the node #1, the fixed dispersion compensators are selected in the order of the node #2, the node #3, the node #4, and the node #1.

A solid line 1720 indicates the deviation amount between the residual dispersion amount and RDtgt of the optical signal inserted from another communication network to the node #4 and branched from the node #3.

FIG. 18 is a block diagram of a functional configuration of a conventional mesh communication network. As depicted in FIG. 18, a conventional communication network 1800 is a mesh communication network connecting a ring #1 and a ring #2. The ring #1 and the ring #2 each have the same configuration as the conventional communication network 1400 depicted in FIG. 14.

The ring #1 is made up of nodes #11 to #15, each of which includes a fixed dispersion compensator. The ring #2 is made up of nodes #21 to #25, each of which includes a fixed dispersion compensator. The node #12 of the ring #1 and the node #24 of the ring #2 are connected to each other and are hub nodes connecting the ring #1 and the ring #2.

A path 1810 is a path of an optical signal inserted from another communication network into the node #11 of the ring #1, passing through the nodes #12 to #15, and returning to the node #11. A path 1820 is a path of an optical signal inserted from another communication network into the node #21 of the ring #2, passing through the nodes #22 to #25, and returning to the node #21.

A path 1830 is a path of an optical signal inserted from another communication network into the node #15 of the ring #1, passing through the node #11 and the node #12, branched to the ring #2, passing through the node #24, the node #25, and the node #21 of the ring #2, and branched from the node #21 to another communication network.

FIG. 19 is a block diagram of a functional configuration of the hub nodes. In FIG. 19, constituent elements identical to those depicted in FIG. 15 are given the same reference numerals used in FIG. 15 and will not be described. The node #12 of the ring #1 and the node #24 of the ring #2 each have a configuration identical to that of the ROADM node 1500 depicted in FIG. 15 and includes a fixed dispersion compensator 1501.

FIG. 20 is a diagram depicting dispersion compensation design in a conventional mesh communication network. In FIG. 20, reference numeral 2001 denotes characteristics of a deviation amount between the residual dispersion amount and RDtgt of the optical signal in the ring #1. Reference numeral 2002 denotes characteristics of a deviation amount between the residual dispersion amount and RDtgt of the optical signal in the ring #2.

A solid line 2010 indicates a design example of the dispersion compensation using the node #11 as a starting node. A solid line 2020 indicates a design example of the dispersion compensation using the node #21 as a starting node.

A heavy line 2030 indicates the deviation amount between the residual dispersion amount and RDtgt of the optical signal inserted from the node #15 of the ring #1, passing through the node #11 and the node #12, branched to the ring #2 (reference numeral 2003), passing through the node #24, the node #25, and the node #21 of the ring #2, and branched from the node #21 as in the case of the path 1830.

However, it is problematic in the above conventional technology that the amount of deviation between the residual dispersion amount and RDtgt increases depending on the amount of dispersion compensation by a fixed dispersion compensator. For example, in the ring communication network 1400 depicted in FIG. 14, Δ is assumed as a step amount of the dispersion compensation amount of the fixed dispersion compensator 1501 included in the nodes #1 to #4. In this case, as depicted in FIG. 17, the deviation amount between the residual dispersion amount and RDtgt of the optical signal is ±Δ/2 at maximum in the nodes #1 to #4 for the optical signal inserted from the node #1.

Sine the dispersion compensation design is performed assuming that the residual dispersion amount of the optical signal passing through the node #1 is RDtgt, if the residual dispersion amount of the optical signal passing through the node #1 is not RDtgt, it is problematic that the deviation amount between the residual dispersion amount and RDtgt is increased according to the fixed amount of the dispersion compensation by the fixed dispersion compensator 1501 included in the node #1.

For example, in the communication network 1400 designed as in the design example 1710 of FIG. 17, it is assumed that an optical signal having the residual dispersion amount of RDtgt is inserted from another communication network to the node #4. In this case, the residual dispersion amount of the optical signal passing through the node #1 is not RDtgt depending on the step amount Δ of the fixed dispersion compensator 1501 of the node #1.

Therefore, a residual dispersion amount in the nodes #1 to #4 is generated as indicated by reference numeral 1720 and the deviation amount between the residual dispersion amount and RDtgt becomes ±3Δ/2 at maximum in the nodes #1 to #4. Therefore, if the step amount Δ of the fixed dispersion compensator is increased, the deviation amount between the residual dispersion amount and RDtgt increases in the branched optical signal.

In the mesh communication network 1800 depicted in FIG. 18, if the residual dispersion amount of the optical signal passing through the hub node is not RDtgt, it is problematic that the deviation amount between the residual dispersion amount and RDtgt is increased. For example, in the communication network 1800 designed as in the design examples 2010 and the design example 2020 of FIG. 20, it is assumed that an optical signal is transmitted through a path over the ring #1 and the ring #2.

In this case, the residual dispersion amount of the optical signal passing through the node #12 is not RDtgt according to the step amount Δ of the fixed dispersion compensator of the node #12. Therefore, a residual dispersion amount in the nodes is generated as indicated by the heavy line 2030 and the deviation amount between the residual dispersion amount and RDtgt becomes ±5Δ/2 at maximum in the nodes. Therefore, if the step amount Δ of the fixed dispersion compensator is increased, the deviation amount between the residual dispersion amount and RDtgt increases in the branched optical signal.

Therefore, it is problematic that communication characteristics deteriorate since the deterioration of the optical signal increases due to the wavelength dispersion. If the step amount Δ of the fixed dispersion compensator is reduced to diminish the deviation between the residual dispersion amount and RDtgt of the branched optical signal, it is problematic that the costs of design and maintenance of the communication networks increase since the number and the types of necessary fixed dispersion compensators increase.

Although it is conceivable that a variable dispersion compensator is used for diminishing the deviation amount between the residual dispersion amount and RDtgt of the branched optical signal, the cost of the communication networks increases if variable dispersion compensators are applied to all the nodes since variable dispersion compensators are generally expensive. If variable dispersion compensators are used, since the eye opening deteriorates in the optical signal passing through a multiplicity of the dispersion compensators due to the passing band characteristics thereof, arising in a problem in that the communication characteristics deteriorate.

### SUMMARY

According to an aspect of an embodiment, a communication network includes a starting node that has a variable dispersion compensator that performs dispersion compensation at a variable dispersion compensation amount such that a residual dispersion amount of an optical signal transmitted therethrough becomes a predetermined reference residual dispersion amount; and plural nodes that are subjected to dispersion compensation design using the starting node as a starting point and that include fixed dispersion compensators selected based on the reference residual dispersion amount.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a functional configuration of a communication network according to a first embodiment;

FIG. 2 is a block diagram of a functional configuration of a ROADM node;

FIG. 3 is a flowchart of dispersion compensation design of the communication network according to the first embodiment;

FIG. 4 is diagram depicting the dispersion compensation design (the number of nodes is k) of the communication network according to the first embodiment;

FIG. 5 depicts the dispersion compensation design (the number of nodes is four) of the communication network according to the first embodiment;

FIG. 6 is a block diagram of a functional configuration of a communication network according to an example of the first embodiment;

FIG. 7 is a table of exemplary design values of the communication network depicted in FIG. 6;

FIG. 8 is a block diagram of a functional configuration of a communication network according to a second embodiment;

FIG. 9 is a block diagram of a functional configuration of hub nodes;

FIG. 10 is diagram depicting dispersion compensation design in the communication network according to the second embodiment;

FIG. 11 is a block diagram of a functional configuration of a communication network according to an example of the second embodiment;

FIG. 12 is a table of exemplary design values of ring #1 depicted in FIG. 6;

FIG. 13 a table of exemplary design values of ring #2 depicted in FIG. 11;

FIG. 14 is a block diagram of a functional configuration of a conventional ring communication network;

FIG. 15 is a block diagram of a functional configuration of a ROADM node;

FIG. 16 is a diagram depicting changes in a cumulative residual dispersion amount in a communication network;

FIG. 17 is a diagram depicting dispersion compensation design in a conventional ring communication network;

FIG. 18 is a block diagram of a functional configuration of a conventional mesh communication network;

FIG. 19 is a block diagram of a functional configuration of hub nodes; and

FIG. 20 is a diagram depicting dispersion compensation design in a conventional mesh communication network.

### DESCRIPTION OF EMBODIMENTS

Preferred embodiments of the present invention will be explained with reference to the accompanying drawings.

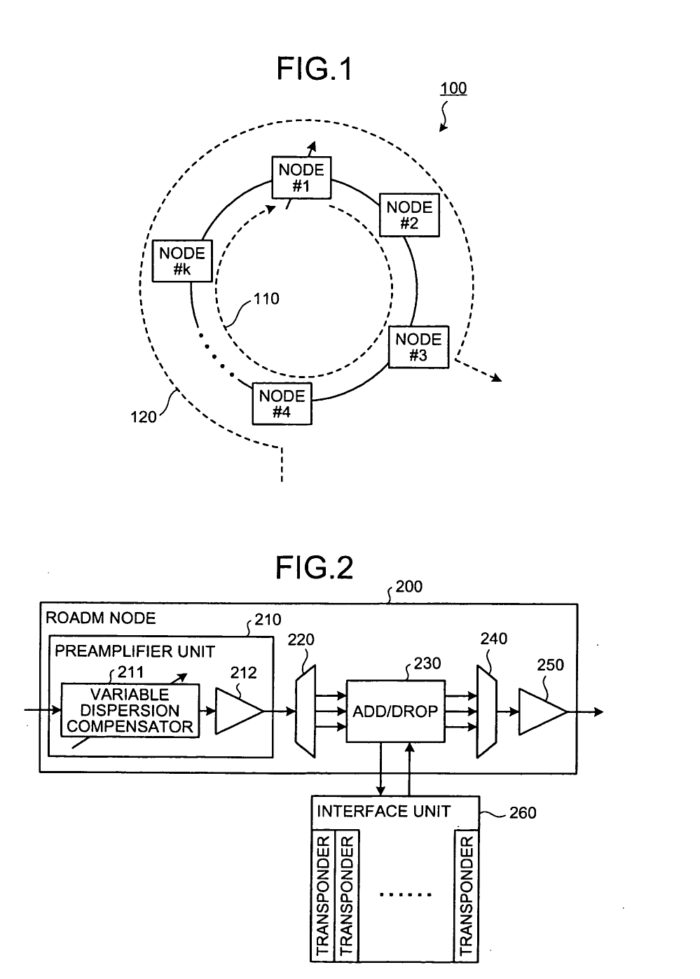

FIG. 1 is a block diagram of a functional configuration of a communication network according to a first embodiment. As depicted in FIG. 1, a communication network 100 according to the first embodiment is ROADM made up of k nodes #1 to #k connected in a ring shape. The communication network 100 is a communication network subject to dispersion compensation design using the node #1 as a starting node.

The communication network 100 transmits a WDM optical signal, which is a wavelength-multiplexed optical signal, and branches each wavelength (channel) of the WDM optical signal to another communication network or inserts an optical signal transmitted from another communication network. The node #1 is a ROADM node that includes a variable dispersion compensator. Each of the nodes #2 to #k is a ROADM node that includes a fixed dispersion compensator (see FIG. 15).

A path 110 is a path of an optical signal inserted from another communication network into the node #1, passing through the node #2, the node #3, the node #4, . . . , and the node #k, and returning to the node #1. A path 120 indicates a path of an optical signal inserted from another communication network into the node #4, passing through the node #k, the node #1, the node #2, and the node #3, and branched from the node #3 to another communication network.

FIG. 2 is a block diagram of a functional configuration of a ROADM node. A ROADM node 200 is an exemplary configuration of the node #1 depicted in FIG. 1 and includes a preamplifying unit 210, a wavelength demultiplexer 220, a add/drop unit 230 (Add/Drop), a wavelength multiplexer 240, and a post-amplifying unit 250. The add/drop unit 230 is connected to an interface unit 260 that performs transmission with another communication network.

The ROADM node 200 branches (drops) a portion of the WDM optical signal wavelength-multiplexed and transmitted from another ROADM node (the node #k) of the communication network 100 and transmits the portion to another communication network through the interface unit 260. The ROADM node 200 receives an optical signal transmitted from another communication network through the interface unit 260 and inserts (adds) the optical signal into the WDM optical signal passing through the ROADM node 200.

The preamplifying unit 210 includes a variable dispersion compensator 211 and an amplifier 212. The variable dispersion compensator 211 performs dispersion compensation by a variable dispersion compensation amount with respect to a WDM optical signal transmitted from another node of the communication network 100. The variable dispersion compensator 211 is a Fiber Bragg Gating (FBG), a VIPA plate, or a ring resonator, for example.

The variable dispersion compensator 211 outputs the dispersion-compensated optical signal to the amplifier 212. The amplifier 212 amplifies and outputs to the wavelength demultiplexer 220, the optical signal output from the variable dispersion compensator 211. The wavelength demultiplexer 220 demultiplexes the optical signal output from the preamplifying unit 210. The wavelength demultiplexer 220 outputs each of the demultiplexed optical signals to the add/drop unit 230.

The add/drop unit 230 individually outputs each of the optical signals output from the wavelength demultiplexer 220 through switching of a switch not depicted, etc., to the wavelength multiplexer 240 or the interface unit 260. The add/drop unit 230 outputs the optical signal output from the interface unit 260 to the wavelength multiplexer 240.

The wavelength multiplexer 240 wavelength-multiplexes each of the optical signals output from the add/drop unit 230. The wavelength multiplexer 240 outputs the wavelength-multiplexed WDM optical signal to the post-amplifying unit 250. The post-amplifying unit 250 amplifies and transmits the WDM optical signal output from the wavelength multiplexer 240 to another node (the node #2) of the communication network 100.

The interface unit 260 is made up of transponders. The interface unit 260 transmits the optical signal output from the add/drop unit 230 to another communication network through the transponders. The interface unit 260 outputs to the add/drop unit 230, the optical signal received from another communication network, through a transponder.

The dispersion compensation design of the communication network 100 will be described. It will hereinafter be assumed that the residual dispersion of the optical signal inserted into the communication network 100 is RDtgt (reference residual dispersion amount). In the dispersion compensation design of the communication network 100, the dispersion compensation amounts of the nodes #1 to #k are designed such that the dispersion compensation amounts of the optical signals branched from the respective nodes #1 to #k come closer to RDtgt.

The node #1 having the variable dispersion compensator 211 is determined as a starting node for designing the dispersion compensation amount. Fixed dispersion compensators of the nodes #2 to #k are selected such that a deviation amount between the residual dispersion amount and RDtgt of the branched optical signal is minimized regardless of which node the optical signal inserted into the node #1 is branched from among the nodes #2 to #k. This allows the residual dispersion amount of the branched signal to fall within a dispersion tolerance (predetermined range).

It is assumed that RD(n) denotes a residual dispersion amount of an optical signal inserted from the node #1 and branched from the node #n. It is assumed that RDtgt(n) denotes the optimum residual dispersion amount of an optical signal branched from a node #n. A deviation amount d(1,n) between the residual dispersion amount and RDtgt of the optical signal inserted from the node #1 and branched from the node #n may be represented by equation (1).

d(1,n)=RD(n)−RDtgt(n) (1)

Assuming that k denotes the number of nodes making up the communication network 100, a deviation amount d(i,j) between the residual dispersion amount and RDtgt of an optical signal inserted from a node #i and branched from a node #j may be represented by equation (2).

d(i,j)=−d(1,i)+d(1,j)+d(1,k+1) (2)

where i, j=1, 2, . . . , k.

A first term of the right-hand side of equation (2) indicates the deviation amount between the residual dispersion amount and RDtgt of the optical signal inserted from the node #1 and branched from the node #i. A second term indicates the deviation amount between the residual dispersion amount and RDtgt of the optical signal inserted from the node #1 and branched from the node #j.

A third term indicates the deviation amount between the residual dispersion amount and RDtgt of the optical signal inserted from the node #1 and branched from the node #1. The deviation amount of the third term is a deviation amount between a residual dispersion amount and RDtgt when an optical signal inserted into the node #1 passes through the node #2, . . . , the node #k, and the node #1 to be branched from the node #1, for example.

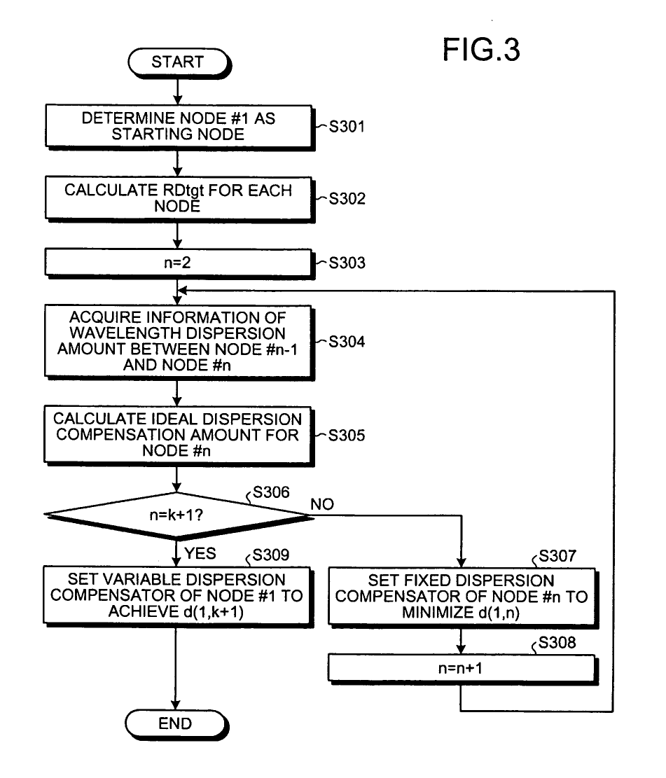

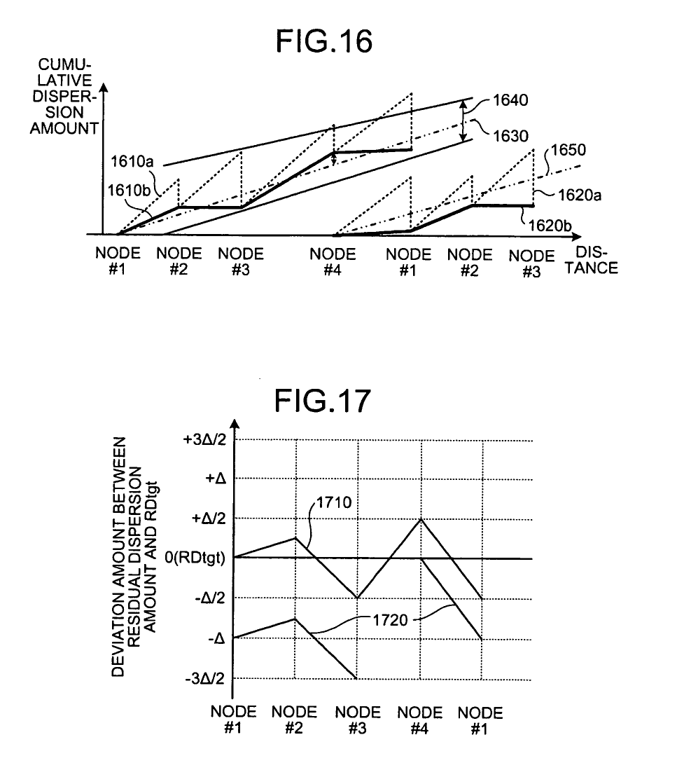

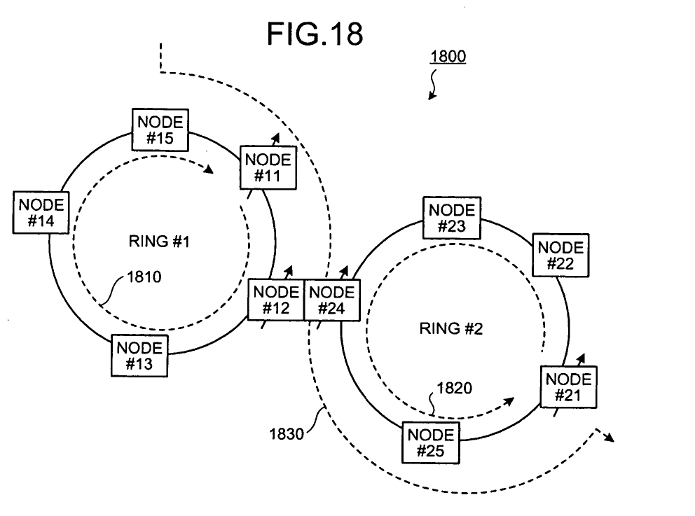

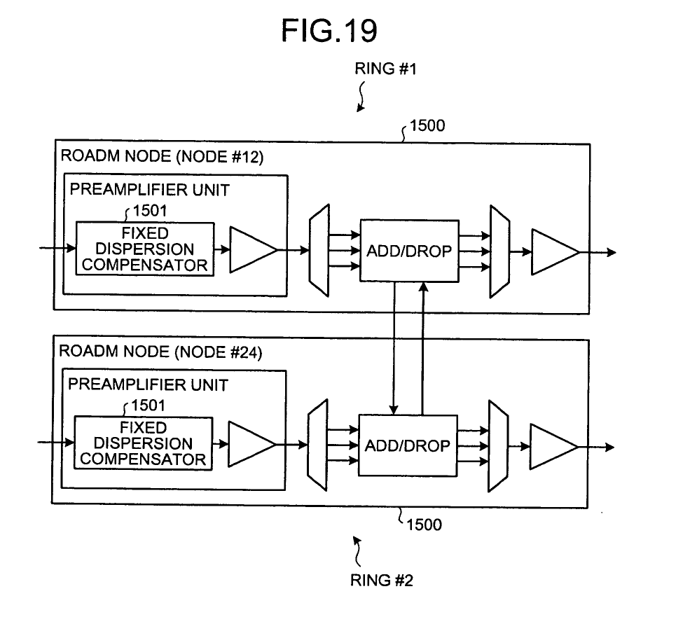

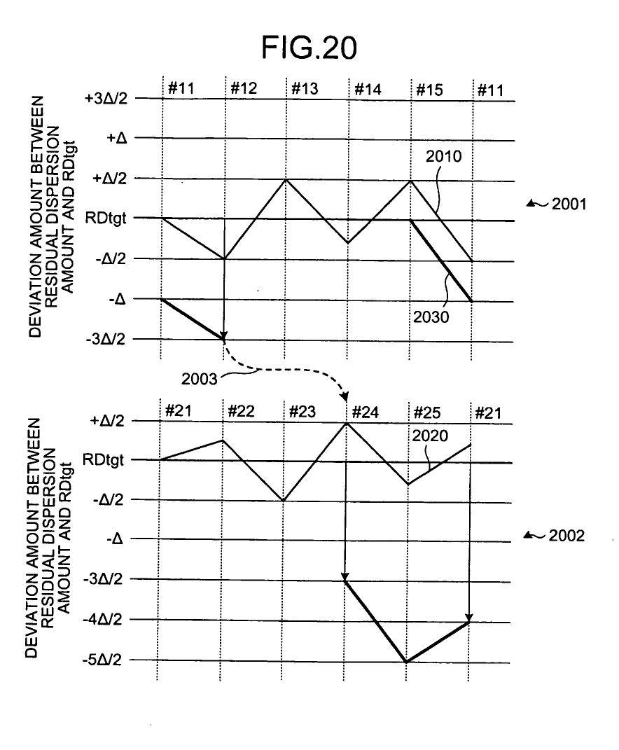

FIG. 3 is a flowchart of the dispersion compensation design of the communication network according to the first embodiment. As depicted in FIG. 3, the node #1 is determined as a starting node that is the starting point of the dispersion compensation design (step S301). RDtgt (see FIG. 16) in each of the nodes #1 to #k is calculated (step S302). RDtgt (predetermined reference residual dispersion amount) in each of the nodes #1 to #k is preliminarily calculated based on information of a transmission path or acquired from a database.

The node #n subjected to the dispersion compensation design is changed to the node #2 (n=2) (step S303). Information is acquired for a wavelength dispersion amount generated in a transmission path between the node #n−1 and the node #n (step S304). The information of the wavelength dispersion amount generated in the transmission path between the node #n−1 and the node #n is calculated based on information of the span and characteristics of the transmission path between the node #n−1 and the node #n.

An ideal dispersion compensation amount for the node #n is then calculated (step S305). The ideal dispersion compensation amount of the node #n is a dispersion compensation amount when the deviation amount d(1,n) is zero between the residual dispersion amount and RDtgt of the optical signal inserted from the node #1 and branched from the node #n. The ideal dispersion compensation amount of the node #n is calculated based on the residual dispersion amount of the optical signal branched from the node #n−1 and the information of the wavelength dispersion amount calculated at step S304.

It is determined whether the node #n under the dispersion compensation design is the node #1 (n=k+1) (step S306). If the node #n is not the node #1 (step S306: NO), the fixed dispersion compensator of the node #n is selected such that d(1,n) is minimized (step S307). The node #n subjected to the dispersion compensation design is changed to the node #n+1 (n=n+1) (step S308) and the process returns to step S304 and continues.

If the node #n is the node #1 at step S306 (step S306: YES), the dispersion compensation amount of the variable dispersion compensator of the node #1 is set such that the deviation amount d(1,k+1) becomes zero between the residual dispersion amount and RDtgt of the optical signal inserted from the node #1, passing through the nodes #2 to #k, and branched from the node #1 (step S309), and the dispersion compensation design of the communication network is terminated.

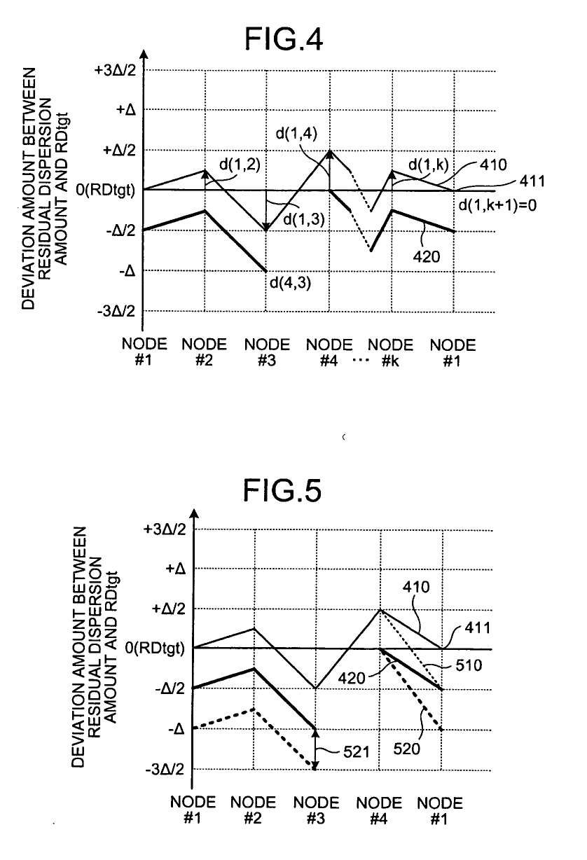

FIG. 4 depicts the dispersion compensation design (the number of nodes is k) of the communication network according to the first embodiment. FIG. 4 depicts the dispersion compensation design when the number of nodes of the communication network 100 is k (see FIG. 1). In FIG. 4, the horizontal axis indicates the nodes #1 to #k through which the optical signal passes. The vertical axis indicates a deviation amount between the residual dispersion amount and RDtgt of the optical signal.

A solid line 410 indicates the dispersion compensation design using the node #1 as the starting node. On the assumption that the optical signal having the residual dispersion amount of RDtgt is inserted into the node #1, fixed dispersion compensators are selected in the order of the node #2, the node #3, . . . , and the node #k such that the deviation amounts d(1,2) to d(1,k) between the residual dispersion amounts and RDtgt of the optical signals branched from the nodes are minimized.

If a fixed dispersion compensator having a step amount of Δ is used, since RD(n) of the right-hand side of the equation (1) may be adjusted by Δ, the maximum value of d(1,n) of the left-hand side of the equation (1) may be constrained to ±Δ/2 by selecting the optimum fixed dispersion compensator. Therefore, the maximum value of the deviation amount d(1,n) may be constrained to ±Δ/2 between the residual dispersion amount and RDtgt of the optical signal inserted from the node #1 and branched from any one of the nodes #2 to #k.

Each of the first, second, and third terms of the right-hand side of the equation (2) is ±Δ/2 at maximum. As denoted by reference numeral 411, the third term of the right-hand side of the equation (2) may be set to zero by setting the dispersion compensation amount of the variable dispersion compensator 211 of the node #1 such that d(1,k+1) becomes zero. Therefore, the maximum value of the deviation amount d(i,j) may be constrained to ±Δ between the residual dispersion amount and RDtgt of the optical signal inserted from the node #i and branched from any one of the nodes #j.

For example, a heavy line 420 indicates the deviation amount between the residual dispersion amount and RDtgt of the optical signal inserted from the node #4, passing through the node #k and the nodes #1 to #3, and branched from the node #3 as in the case of the path 120 of FIG. 1. As indicated by the heavy line 420, if the optical signal is inserted from the node #4, d(4,3) having the largest d(i,j) may be constrained to −Δ although the residual dispersion amount of the optical signal passing through the node #1 is not RDtgt.

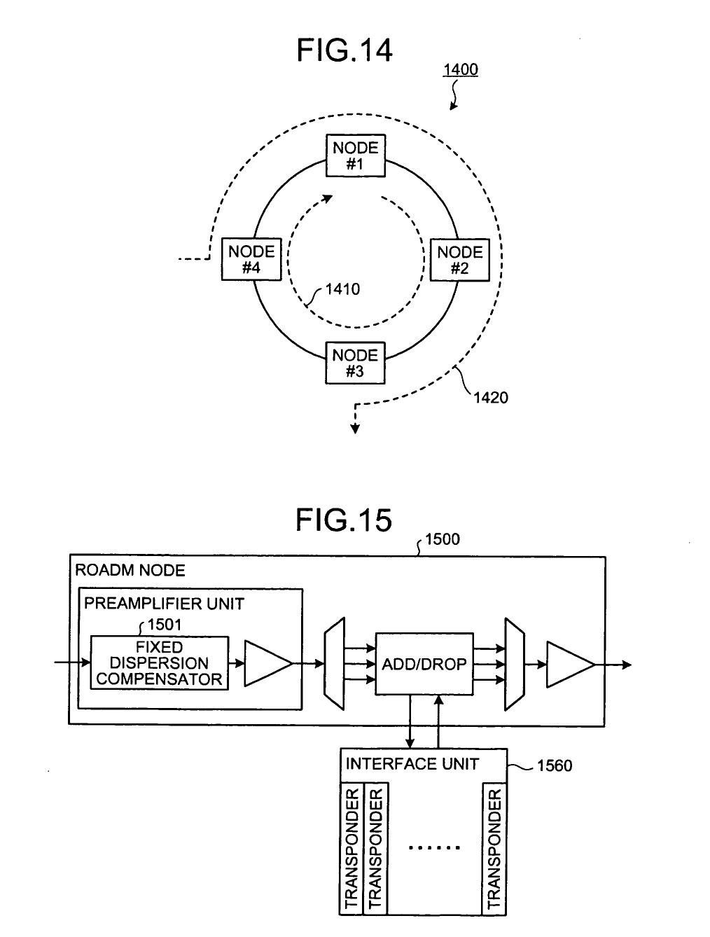

FIG. 5 depicts the dispersion compensation design (the number of nodes is four) of the communication network according to the first embodiment. FIG. 5 depicts the dispersion compensation design when the number of nodes of the communication network 100 is four (see FIG. 14). In FIG. 5, the portions identical to those depicted in FIG. 4 are given the same reference numerals used in FIG. 4 and will not be described. A dotted line 510 indicates the dispersion compensation design using the node #1 as the starting node (see FIG. 17) on the assumption that the dispersion compensator included in the node #1 is the fixed dispersion compensator.

A heavy dotted line 520 indicates the deviation amount between the residual dispersion amount and RDtgt of the optical signal inserted from the node #4, passing through the nodes #1 to #3, and branched from the node #3 when it is assumed that the dispersion compensator included in the node #1 is the fixed dispersion compensator. As depicted by the heavy dotted line 520, when it is assumed that the dispersion compensator included in the node #1 is the fixed dispersion compensator, the deviation amount is −3Δ/2 between the residual dispersion amount and RDtgt of the optical signal inserted from the node #4, passing through the nodes #1 to #3, and branched from the node #3.

On the other hand, as depicted by the heavy line 420, if the dispersion compensator included in the node #1 is the variable dispersion compensator 211, the deviation amount is −Δ between the residual dispersion amount and RDtgt of the optical signal inserted from the node #4, passing through the nodes #1 to #3, and branched from the node #3. Therefore, as indicated by reference numeral 521, the deviation amount between the dispersion amount and RDtgt is improved by 33% when the node #1 is equipped with the variable dispersion compensator 211.

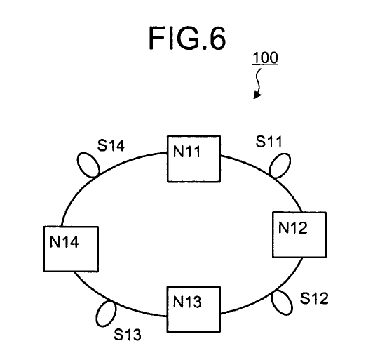

FIG. 6 is a block diagram of a functional configuration of a communication network according to an example of the first embodiment. As depicted in FIG. 6, it is assumed that the number of nodes of the communication network 100 according to the example of the first embodiment is four and that the nodes are nodes N11 to N14. It is assumed that a transmission path between the node N11 and the node N12 is a transmission path S11, that a transmission path between the node N12 and the node N13 is a transmission path S12, that a transmission path between the node N13 and the node N14 is a transmission path S13, and that a transmission path between the node N14 and the node N11 is a transmission path S14.

The node N11 is the starting node of the dispersion compensation design of the communication network 100 and includes the variable dispersion compensator 211. The nodes N12 to N14 are nodes subjected to the dispersion compensation design using the node N11 as the starting point and include the fixed dispersion compensators. The transmission paths S11 to S14 are assumed to be single mode fibers (SMF) having a wavelength dispersion coefficient of 17 ps/nm/km. The number of steps of the fixed dispersion compensators included in the nodes N12 to N14 is assumed to be 200 ps/nm.

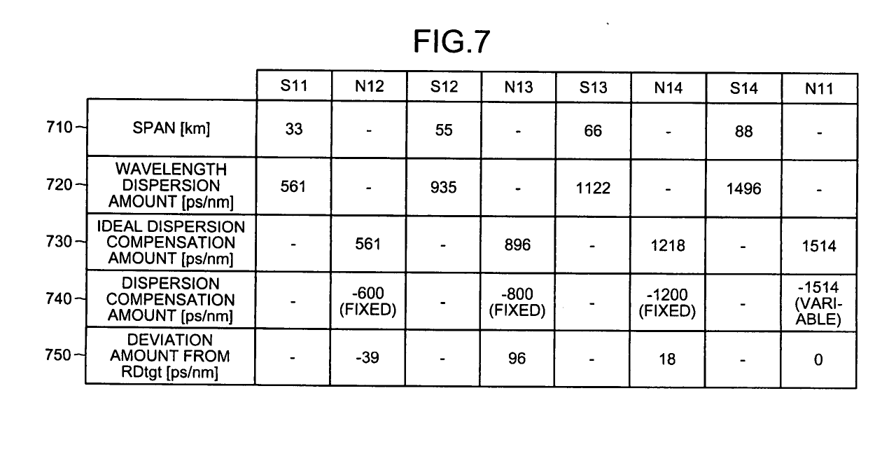

FIG. 7 depicts exemplary design values of the communication network depicted in FIG. 6. In FIG. 7, an item 710 indicates the spans of the transmission paths S11 to S14. An item 720 indicates wavelength dispersion amounts generated in the transmission paths S11 to S14. An item 730 indicates ideal dispersion compensation amounts of the nodes N11 to N14. An item 740 indicates dispersion compensation amounts of the nodes N11 to N14. An item 750 indicates deviation amounts d(i,j) between the residual dispersion amount and RDtgt of the optical signal branched from the nodes N11 to N14.

The wavelength dispersion amounts 720 generated in the transmission paths S11 to S14 are calculated. From the multiplication of the spans 710 of the transmission paths S11 to S14 and the wavelength dispersion coefficient of 17 ps/nm/km, the wavelength dispersion amounts 720 generated in the transmission paths S11 to S14 may be calculated as follows:

S11:561 ps/nm

S12:935 ps/nm

S13:1122 ps/nm

S14:1496 ps/nm

The fixed dispersion compensators of the nodes N12 to N14 are selected. The ideal dispersion compensation amounts 730, the actual dispersion compensation amounts 740, and the deviation amounts 750 from RDtgt of the nodes N12 to N14 may be calculated as follows:

N12: the ideal dispersion compensation amount 561 ps/nm; the actual compensation amount 600 ps/nm; from RDtgt, the deviation amount d(N11,N12)−39 ps/nm

N13: the ideal dispersion compensation amount 896 ps/nm; the actual compensation amount 800 ps/nm; from RDtgt, the deviation amount d(N11,N13)96 ps/nm

N14: the ideal dispersion compensation amount 1218 ps/nm; the actual compensation amount 1200 ps/nm; from RDtgt, the deviation amount d(N11,N14)18 ps/nm

The dispersion compensation amount is set for the variable dispersion compensator 211 of the node N11, which is the starting node. The ideal dispersion compensation amount 730, the actual dispersion compensation amount 740, and the deviation amount 750 from RDtgt of the node N11 may be calculated as follows:

N11: the ideal dispersion compensation amount 1514 ps/nm; the actual compensation amount 1514 ps/nm; from RDtgt, the deviation amount 0 ps/nm.

From the above design, the deviation amount d(Ni,Nj) between the residual dispersion amount and RDtgt of the optical signal inserted from the node Ni and branched from the node Nj may be calculated as follows and d(Ni,Nj) consistently falls within ±200 ps/nm:

the deviation amount d(N12,N13) in the path of N12→N13=−d(N11,N12)+d(N11,N13)=39+96=135 ps/nm

the deviation amount d(N12,N14) in the path of N12→N14=−d(N11,N12)+d(N11,N14)=39+18=57 ps/nm

the deviation amount d(N12,N11) in the path of N12→N11=−d(N11,N12)+d(N11,N11)=39+0=39 ps/nm

the deviation amount d(N13,N14) in the path of N13→N14=−d(N11,N13)+d(N11,N14)=−96+18=−78 ps/nm

the deviation amount d(N13,N11) in the path of N13→N11=−d(N11,N13)+d(N11,N11)=−96+0=−96 ps/nm

the deviation amount d(N13,N12) in the path of N13→N12=−d(N11,N13)+d(N11,N12)=−96−36=−135 ps/nm

the deviation amount d(N14,N11) in the path of N14→N11=−d(N11,N14)+d(N11,N11)=−18+0=−18 ps/nm

the deviation amount d(N14,N12) in the path of N14→N12=−d(N11,N14)+d(N11,N12)=−18−39=−57 ps/nm

the deviation amount d(N14,N13) in the path of N14→N13=−d(N11,N14)+d(N11,N13)=−18+96=78 ps/nm

According to the communication network of the first embodiment, since the starting node of the dispersion compensation design of the communication network has the variable dispersion compensator, the maximum deviation amount between the residual dispersion amount and RDtgt may be constrained to the step amount Δ of the fixed dispersion compensator in the transmissions among all the nodes of the communication network. Therefore, the communication characteristics may be improved by constraining the deterioration of optical signals due to the wavelength dispersion.

Since the variable dispersion compensator is applied to the starting node alone among the nodes of the communication network, the cost of the communication network is reduced. For example, if VIPA is used as the variable dispersion compensator, VIPA is applied to the starting node alone among the nodes of the communication network, the eye opening of the optical signal does not deteriorate and the communication characteristics is improved.

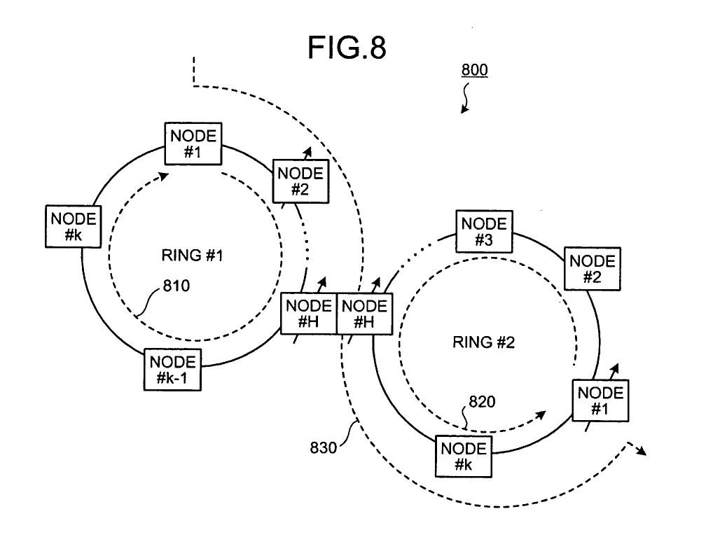

FIG. 8 is a block diagram of a functional configuration of a communication network according to a second embodiment. As depicted in FIG. 8, a communication network 800 according to the second embodiment is a mesh communication network connecting a ring #1 and a ring #2. The ring #1 and the ring #2 each have a configuration identical to that of the communication network 100 according to the first embodiment.

The ring #1 and the ring #2 are each made up of nodes #1 to #k. Nodes #H included in both the ring #1 and the ring #2 are connected to each other and are hub nodes connecting the ring #1 and the ring #2. The nodes #H are ROADM nodes that include a variable dispersion compensator.

The respective nodes #1 of the ring #1 and the ring #2 are the starting nodes of the dispersion compensation design of the ring #1 and the ring #2, respectively and are ROADM nodes that include a variable dispersion compensator. The nodes #2, #k−1, and #k are ROADM nodes (see FIG. 15) that include fixed dispersion compensators.

A path 810 is a path of an optical signal inserted from another communication network into the node #1 of the ring #1, passing through the node #2, . . . , the node #H, and the node #k, and returning to the node #1. A path 820 is a path of an optical signal inserted from another communication network into the node #1 of the ring #2, passing through the node #2, the node #3, the node #H, . . . , and the node #k, and returning to the node #1.

A path 830 is a path of an optical signal inserted from another communication network into the node #1 of the ring #1, passing through the node #2 and the node #H, branched to the ring #2, passing through the node #H, the node #k, and the node #1 of the ring #2, and branched from the node #1 to another communication network.

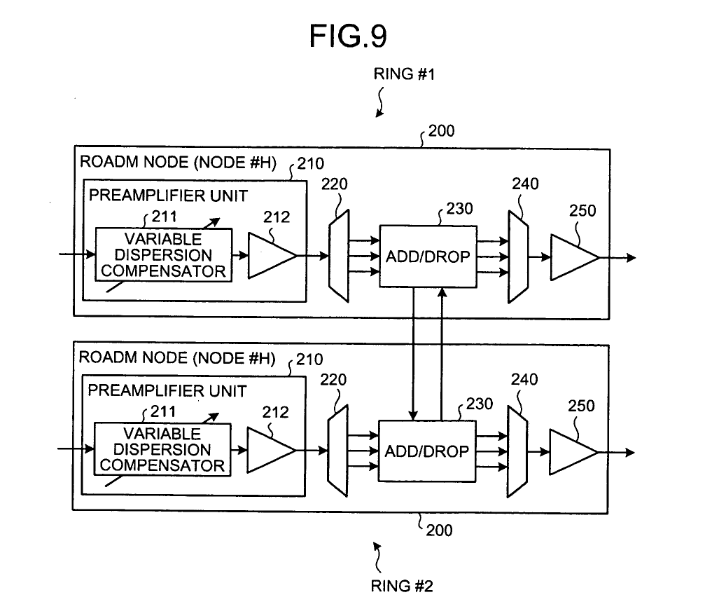

FIG. 9 is a block diagram of a functional configuration of the hub nodes. In FIG. 8, constituent elements identical to those depicted in FIG. 2 are given the same reference numerals used in FIG. 2 and will not be described. The respective nodes #H of the ring #1 and the ring #2 have a configuration identical to that of the ROADM node 200 depicted in FIG. 2 and include the fixed dispersion compensator 211.

The add/drop unit 230 of the node H of the ring #1 outputs the respective optical signals output from the wavelength demultiplexer 220 to the wavelength multiplexer 240 or the ring #2. The add/drop unit 230 of the node H of the ring #1 outputs the optical signal output from the ring #2 to the wavelength multiplexer 240 of the node #H of the ring #1.

The add/drop unit 230 of the node H of the ring #2 outputs the respective optical signals output from the wavelength demultiplexer 220 to the wavelength multiplexer 240 or the ring #1. The add/drop unit 230 of the node H of the ring #2 outputs the optical signal output from the ring #1 to the wavelength multiplexer 240 of the node #H of the ring #2.

The dispersion compensation design is individually performed for the ring #1 and the ring #2 in the communication network 800. The procedures of the dispersion compensation design of each of the ring #1 and the ring #2 are identical to those depicted in FIG. 3 and will not be described.

A deviation amount d(i,j) between the residual dispersion amount and RDtgt of the optical signal inserted from the node #1 of the ring #1 and branched from the node #j of the ring #2 may be represented by equation (3).

d(i,j)=d1(i,H)+d2(H,j) (3)

A first term of the right-hand side of equation (3) indicates the deviation amount between the residual dispersion amount and RDtgt of the optical signal inserted from the node #1 of the ring #1 and branched from the node #H to the ring #2. A second term indicates the deviation amount between the residual dispersion amount and RDtgt of the optical signal inserted from the node #H of the ring #2 and branched from the node #j of the ring #2. The following equations (4) and (5) may represent d1(i,H) and d2(H,j), respectively, of the right-hand side of the equation (3).

d1(i,H)=−d1(1,i)+d1(1,H)+d1(1,k+1) (4)

where, i=1, 2, . . . , H, . . . , k

d2(H,j)=−d2(1,H)+d2(1,j)+d2(1,k+1) (5)

where, i=1, 2, . . . , H, . . . , k

A first term of the right-hand side of equation (4) indicates the deviation amount between the residual dispersion amount and RDtgt of the optical signal inserted from the node #1 of the ring #1 and branched from the node #i of the ring #1. A second term indicates the deviation amount between the residual dispersion amount and RDtgt of the optical signal inserted from the node #1 of the ring #1 and branched from the node #H of the ring #1. A third term indicates the deviation amount between the residual dispersion amount and RDtgt of the optical signal inserted from the node #1 of the ring #1, passing through the nodes #2 to #k of the ring #1, and branched from the node #1 of the ring #1.

A first term of the right-hand side of equation (5) indicates the deviation amount between the residual dispersion amount and RDtgt of the optical signal inserted from the node #1 of the ring #2 and branched from the node #i of the ring #2. A second term indicates the deviation amount between the residual dispersion amount and RDtgt of the optical signal inserted from the node #1 of the ring #2 and branched from the node #H of the ring #2. A third term indicates the deviation amount between the residual dispersion amount and RDtgt of the optical signal inserted from the node #1 of the ring #2, passing through the nodes #2 to #k of the ring #2, and branched from the node #1 of the ring #2.

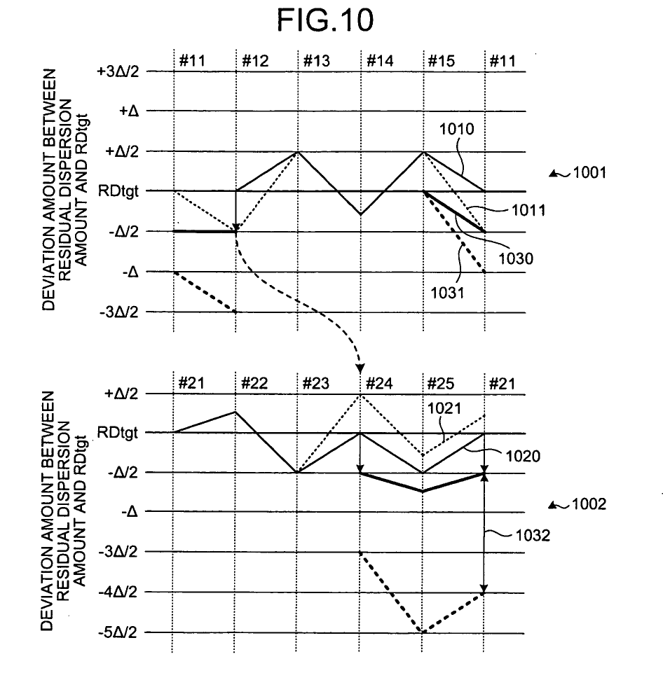

FIG. 10 depicts dispersion compensation design in the communication network according to the second embodiment. In FIG. 10, reference numeral 1001 denotes characteristics of a deviation amount between the residual dispersion amount and RDtgt of the optical signal in the ring #1. Reference numeral 1002 denotes characteristics of a deviation amount between the residual dispersion amount and RDtgt of the optical signal in the ring #2.

A solid line 1010 indicates a design example of the dispersion compensation for ring #1 using the node #11 as a starting node. A dotted line 1011 indicates a design example of the dispersion compensation for ring #1 using the node #11 as a starting node when it is assumed that the dispersion compensator included in the node #11 a fixed dispersion compensator.

A solid line 1020 indicates a design example of the dispersion compensation for ring #2 using the node #21 as a starting node. A dotted line 1021 indicates a design example of the dispersion compensation for ring #2 using the node #21 as a starting node when it is assumed that the dispersion compensator included in the node #21 a fixed dispersion compensator.

A heavy line 1030 indicates the deviation amount between the residual dispersion amount and RDtgt of the optical signal passing through the path 830. A heavy dotted line 1031 indicates the deviation amount between the residual dispersion amount and RDtgt of the optical signal passing through the path 830 when it is assumed that the dispersion compensators included in the node #12 and the node #24 are fixed dispersion compensators.

If a fixed dispersion compensator having a step amount of Δ is used, each of the first to third terms of the right-hand side of equation (4) and the first to third terms of the right-hand side of equation (5) is ±Δ/2 at maximum. The third terms of equations (4) and (5) may be set to zero depending on the setting of the dispersion compensation amount of the variable dispersion compensators 211 included in the node #11 and the node #21. Therefore, the following equations (6) and (7) may respectively represent d1(i,H) and d2(H,j), represented in equations (4) and (5).

d1(i,H)=−d1(1,i)+d1(1,H) (6)

where, i=1, 2, . . . , H, . . . k

d2(H,j)=−d2(1,H)+d2(1,j) (7)

where, i=1, 2, . . . , H, . . . k

Therefore, the maximum value of the deviation amount d(i,j) between the residual dispersion amount and RDtgt of the optical signal inserted from the node #i of the ring #1 and branched from the node #j of the ring #2, is constrained to ±2Δ. Although the maximum value is ±2Δ since the number of the rings making up the communication network 800 is two, if the number of the rings making up the communication network 800 is three, four, etc., the maximum value of d(i,j) is ±3Δ, ±4Δ, etc.

The second term of equation (6) and the second term of equation (7) may be set to zero depending on the setting of the dispersion compensation amount of the variable dispersion compensators 211 included in the node #H. Therefore, the deviation amount d(i,j) between the residual dispersion amount and RDtgt of the optical signal inserted from the node #i of the ring #1 and branched from the node #j of the ring #2 depicted in equation (3) may be represented by the following equation (8).

$$\begin{matrix}d ( i , j ) = d 1 ( i , H ) + d 2 ( H , j ) \\ = - d 1 ( 1 , i ) + d 2 ( 1 j )\end{matrix} \qquad ( 8 )$$

Therefore, the maximum value of the deviation amount d(i,j) between the residual dispersion amount and RDtgt of the optical signal inserted from the node #i of the ring #1 and branched from the node #j of the ring #2, is constrained to ±2Δ. The maximum value of d(i,j) in this case is ±Δ regardless of the number of rings making up the communication network 800.

For example, as indicated by a heavy dotted line 1031, if the dispersion compensators included in the node #12 and the node #24 are the fixed dispersion compensators, the deviation amount between the residual dispersion amount and RDtgt of the light signal passing through the path 830 is −4Δ/2 in the node #21.

On the other hand, as indicated by a heavy line 1030, if the dispersion compensators included in the node #12 and the node #24 are the variable dispersion compensators 211, the deviation amount between the residual dispersion amount and RDtgt is −Δ/2 in the node #21 of the path 830. Therefore, as indicated by reference numeral 1032, the deviation amount between the dispersion amount and RDtgt is improved by 66% when the node #1 is equipped with the variable dispersion compensator 211.

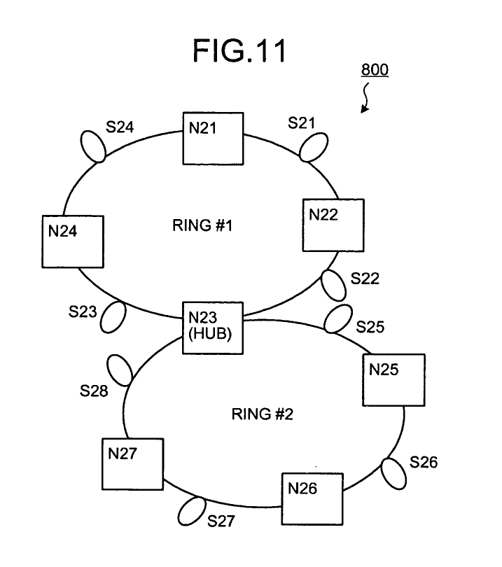

FIG. 11 is a block diagram of a functional configuration of a communication network according to an example of the second embodiment. As depicted in FIG. 11, it is assumed that the numbers of nodes of the ring #1 and the ring #2 of the communication network 800 are four, that the nodes of the ring #1 are nodes N21 to N24, and that the nodes of the ring #2 are nodes N23, and N25 to N27. The node N23 is a node common to the ring #1 and the ring #2, and is a hub node (HUB) connecting the ring #1 and the ring #2.

It is assumed that a transmission path between the node N21 and the node N22 is a transmission path S21, that a transmission path between the node N22 and the node N23 is a transmission path S22, that a transmission path between the node N23 and the node N24 is a transmission path S23, and that a transmission path between the node N24 and the node N21 is a transmission path S24. It is assumed that a transmission path between the node N23 and the node N25 is a transmission path S25, that a transmission path between the node N25 and the node N26 is a transmission path S26, that a transmission path between the node N26 and the node N27 is a transmission path S27, and that a transmission path between the node N27 and the node N23 is a transmission path S28.

In the communication network 800 according to the example of the second embodiment, the node N23 acting as the hub node is defined as the starting node of the ring #1 and the ring #2, respectively. The node N23 includes the variable dispersion compensator 211. The nodes N21, N22, and N24 to N27 are nodes subjected to the dispersion compensation design using the node N23 as the starting point and include the fixed dispersion compensators.

The transmission paths S21 to S28 are assumed to have SMF the wavelength dispersion coefficient of 17 ps/nm/km. The number of steps of the fixed dispersion compensators included in the nodes N21, N22, and N24 to N27 is assumed to be 200 ps/nm.

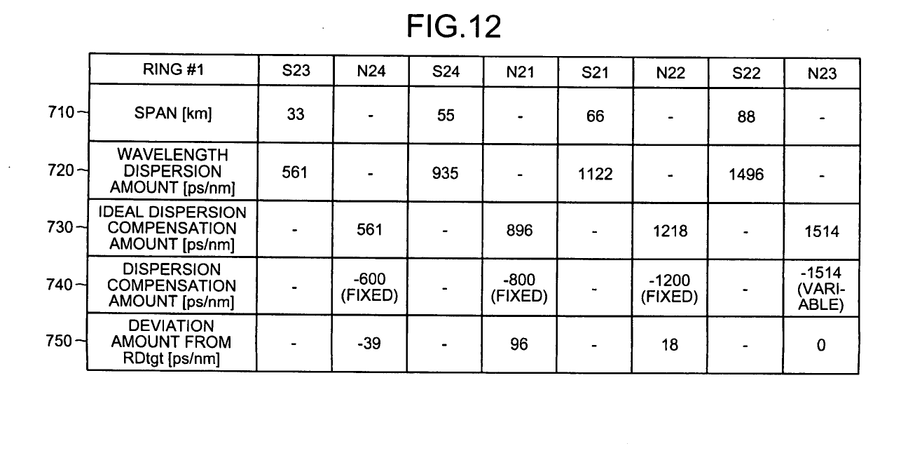

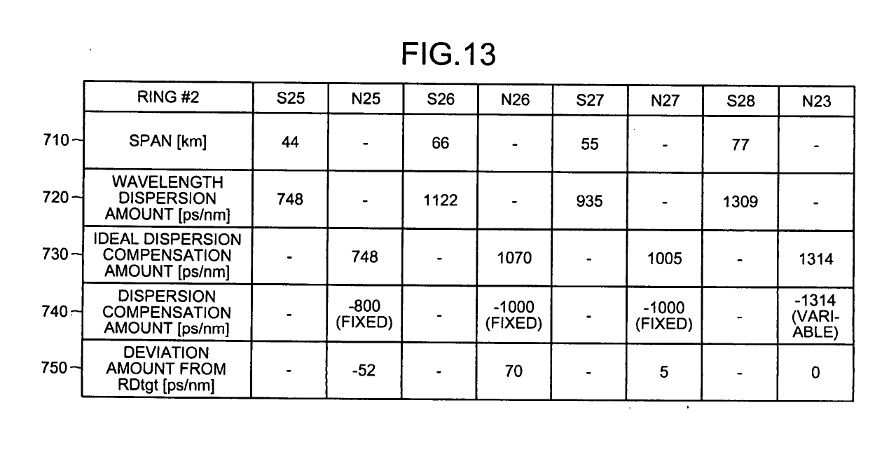

FIG. 12 depicts exemplary design values of the ring #1 depicted in FIG. 6. FIG. 13 depicts exemplary design values of the ring #2 depicted in FIG. 11. Items 710 to 750 of FIGS. 12 and 13 are identical to those depicted in FIG. 7 and, therefore, are given the same reference numerals used in FIG. 7 and will not be described.

The wavelength dispersion amounts 720 generated in the transmission paths S21 to S24 of the ring #1 are calculated. From the multiplication of the spans 710 of the transmission paths S21 to S24 and the wavelength dispersion coefficient of 17 ps/nm/km, the wavelength dispersion amounts 720 generated in the transmission paths S21 to S24 may be calculated as follows:

S23:561 ps/nm

S24:935 ps/nm

S21:1122 ps/nm

S22:1496 ps/nm

The wavelength dispersion amounts 720 generated in the transmission paths S25 to S28 of the ring #2 are then calculated. From the multiplication of the spans 710 of the transmission paths S25 to S28 and the wavelength dispersion coefficient of 17 ps/nm/km, the wavelength dispersion amounts 720 generated in the transmission paths S25 to S28 may be calculated as follows:

S25:748 ps/nm

S26:1122 ps/nm

S27:935 ps/nm

S28:1309 ps/nm

The fixed dispersion compensators of the nodes N22 to N27 are selected. The ideal dispersion compensation amounts 730, the actual dispersion compensation amounts 740, and the deviation amounts 750 from RDtgt of the nodes N22 to N27 may be calculated as follows:

N24: the ideal dispersion compensation amount 561 ps/nm; the actual compensation amount 600 ps/nm; from RDtgt, the deviation amount d(N23,N24)−39 ps/nm

N21: the ideal dispersion compensation amount 896 ps/nm; the actual compensation amount 800 ps/nm; from RDtgt, the deviation amount d(N23,N21)96 ps/nm

N22: the ideal dispersion compensation amount 1218 ps/nm; the actual compensation amount 1200 ps/nm; from RDtgt, the deviation amount d(N23,N22)18 ps/nm

N25: the ideal dispersion compensation amount 748 ps/nm; the actual compensation amount 800 ps/nm; from RDtgt, the deviation amount d(N23,N25)−52 ps/nm

N26: the ideal dispersion compensation amount 1070 ps/nm; the actual compensation amount 1000 ps/nm; from RDtgt, the deviation amount d(N23,N26)70 ps/nm

N27: the ideal dispersion compensation amount 1005 ps/nm; the actual compensation amount 1000 ps/nm; from RDtgt, the deviation amount d(N23,N27)5 ps/nm

The dispersion compensation amount is set for the variable dispersion compensator 211 of the node N23 (on the ring #1 side), which is the starting node. The ideal dispersion compensation amount 730, the actual dispersion compensation amount 740, and the deviation amount 750 from RDtgt of the node N23 (on the ring #1 side) may be calculated as follows:

N23 (on the ring #1 side): the ideal dispersion compensation amount 1514 ps/nm; the actual compensation amount 1514 ps/nm; from RDtgt, the deviation amount 0 ps/nm.

The dispersion compensation amount is set for the variable dispersion compensator 211 of the node N23 (on the ring #2 side), which is the starting node. The ideal dispersion compensation amount 730, the actual dispersion compensation amount 740, and the deviation amount 750 from RDtgt of the node N23 (on the ring #2 side) may be calculated as follows:

N23 (on the ring #2 side): the ideal dispersion compensation amount 1314 ps/nm; the actual compensation amount 1314 ps/nm; from RDtgt, the deviation amount 0 ps/nm.

From the above design, the deviation amount d(Ni,Nj) between the residual dispersion amount and RDtgt of the optical signal inserted from the node Ni and branched from the node Nj consistently falls within ±200 ps/nm. The calculation assumptions of d(Ni,Nj) are identical to those described in the first embodiment and will not be described.

According to the communication network of the second embodiment, since the hub node connecting the communication networks subjected to the individually performed dispersion compensation design includes the variable dispersion compensator, the maximum deviation amount between the residual dispersion amount and RDtgt of the optical signal transmitted over the communication networks may be constrained to the step amount Δ of the fixed dispersion compensator. Therefore, the communication characteristics are improved by constraining the deterioration of optical signals due to wavelength dispersion.

Since the hub node connecting the communication networks subjected to the individually performed dispersion compensation design includes the variable dispersion compensator and this hub node is defined as the starting node of the dispersion compensation design of the communication networks, the effect of the first embodiment is achieved and the maximum deviation amount between the residual dispersion amount and RDtgt of the optical signal transmitted over the communication networks is constrained to the step amount Δ of the fixed dispersion compensator.

As described above, according to the communication network and the design method of the present embodiment, since the starting node of the dispersion compensation design of the communication network includes the variable dispersion compensator, communication characteristics are improved in the transmissions among all the nodes of the communication network. Since the hub node connecting the communication networks subjected to the individually performed dispersion compensation design includes the variable dispersion compensator, the communication characteristics are improved in the transmissions over the communication networks.

Although the ROADM communication network connecting the nodes #1 to #k in a ring shape has been described in the first embodiment, the present invention is generally applicable to communication networks configured by serially connecting a starting node and multiple nodes subjected to the dispersion compensation design using the staring node as a starting point.

Although a mesh communication network configured by connecting the two ring communication networks has been described in the second embodiment, a mesh communication network may generally be considered as plural ring networks connected to each other. Therefore, the present invention is applicable to mesh communication networks other than the mesh communication network described above.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and, scope of the invention.

What is claimed is:

1. A communication network comprising:
a starting node that comprises a variable dispersion compensator that performs dispersion compensation at a variable dispersion compensation amount such that a residual dispersion amount of an optical signal transmitted therethrough becomes a predetermined reference residual dispersion amount; and
a plurality of nodes that are subjected to dispersion compensation design using the starting node as a starting point and that include fixed dispersion compensators selected based on the reference residual dispersion amount.

2. The communication network according to claim 1, wherein the fixed dispersion compensators transmit the optical signal output from the starting node and perform dispersion compensation at a fixed dispersion compensation amount that makes the residual dispersion amount of the optical signal fall within a predetermined range that is based on the reference residual dispersion amount.

3. The communication network according to claim 1, wherein the variable dispersion compensator performs dispersion compensation at a dispersion compensation amount that is set such that the residual dispersion amount of the optical signal output from a node that is among the nodes and on an input side of the starting node, becomes the reference residual dispersion amount.

4. The communication network according to claim 1, wherein the starting node and the nodes are connected in a ring shape.

5. The communication network according to claim 1, wherein the starting node is a hub node that connects to a second communication network.

6. The communication network according to claim 5, wherein the second communication network is a communication network comprising a plurality of nodes subjected to dispersion compensation design using the hub node as the starting point.

7. A communication network comprising:
a hub node that connects to any node among the starting node and the nodes constituting the communication network according to claim 1, and comprises a variable dispersion compensator that performs dispersion compensation at a variable dispersion compensation amount on the optical signal transmitted therethrough.

8. A dispersion compensation design method of a communication network, the dispersion compensation design method comprising:
selecting, based on a reference residual dispersion amount, respective fixed dispersion compensators included in a plurality of nodes of the communication network, the reference residual dispersion amount being a residual dispersion amount of an optical signal transmitted through a starting node of the communication network; and
setting a dispersion compensation amount of a variable dispersion compensator constituting the starting node.

9. The dispersion compensation design method according to claim 8, wherein the setting includes setting the dispersion compensation amount such that the residual dispersion amount of the optical signal output from a node that is among the nodes and on an input side of the starting node, becomes the reference residual dispersion amount.
